(19) United States
(12) Patent Application Publication
(10) Pub. No.: US 2024/0356064 A1
(43) Pub. Date: Oct. 24, 2024

(54) SULFIDE-BASED SOLID ELECTROLYTE, PREPARATION METHOD THEREOF, AND ALL-SOLID STATE BATTERY PREPARED THEREFROM

(71) Applicant: University of Ulsan Foundation for Industry Cooperation, Ulsan (KR)

(72) Inventors: Kwang Sun RYU, Ulsan (KR); Rajesh RAJAGOPAL, Ulsan (KR); Yuvaraj SUBRAMANIAN, Ulsan (KR)

(73) Assignee: University of Ulsan Foundation for Industry Cooperation, Ulsan (KR)

(21) Appl. No.: 18/287,891

(22) PCT Filed: Apr. 19, 2022
(86) PCT No.: PCT/KR2022/005566

§ 371 Date: Oct. 23, 2023

(30) Foreign Application Priority Data
Apr. 21, 2021 (KR) 10-2021-0051447

(51) Int. Cl. H01M 10/0562; H01M 4/02; H01M 4/62

(52) U.S. Cl. CPC H01M 10/0562; H01M 4/625; H01M 2004/027; H01M 2004/028; H01M 2300/008

(57) ABSTRACT

The present invention relates to sulfide-based solid electrolyte, a preparation method thereof, and an all-solid state battery prepared therefrom, and by doping an Li₂S—P₂S₅—LiX (X is F, Cl, Br or I) or Li₂S—P₂S₅—LiX—LiX′ (X and X′ are F, Cl, Br or I, X and X′ being different elements) sulfide-based solid electrolyte system with a metal or a quasi-metal, the sulfide-based solid electrolyte, which has high ionic conductivity, has stability with respect to a lithium metal negative electrode, and is humidity-stable, may be provided.

### TECHNICAL FIELD

The present invention relates to a sulfide-based solid electrolyte, a preparation method thereof, and an all-solid-state battery manufactured therefrom.

### BACKGROUND ART

Lithium-ion batteries are used in many portable applications such as mobile phones, laptops, video cameras, and medical devices, and their high energy density makes them suitable for use in electric vehicles and hybrid electric vehicles.

However, since commercially available lithium-ion batteries use flammable liquid electrolytes, the internal temperature of the battery system rises when a short circuit occurs, and accordingly, there is a risk of explosion, and in order to prevent this, a non-flammable organic electrolyte is used, or a device for suppressing the temperature rise or a system for preventing short circuits is additionally required.

Therefore, a lot of research is being conducted on solid electrolytes that have excellent thermal stability at a high temperature, a simple battery design, and low manufacturing costs in place of liquid electrolytes.

Among the solid electrolytes, oxide-based solid electrolytes and sulfide-based solid electrolytes are attracting attention due to their characteristics of good compatibility, miniaturization, and negligible electronic conductivity, and in particular, the sulfide-based solid electrolytes have higher ionic conductivity, mechanical stability, and electrochemical stability against lithium metal than oxide-based solid electrolytes.

However, the ionic conductivity of the sulfide-based solid electrolyte is still low compared to conventional organic liquid electrolytes, and the electrolyte has problems in that it has low stability against moisture and low cycle stability due to side reactions with a lithium metal negative electrode.

Recently, Li₇P₂S₈X(3Li₂S—P₂S₅—LiX) or Li₆PS₅X(5Li₂S—P₂S₅-2LiX)-type solid electrolytes in which a halogen is added to the Li₂S—P₂S₅ solid electrolyte system have been found to have high ionic conductivity and electrochemical properties. However, the Li₆PS₅X(5Li₂S—P₂S₅-2LiX)-type solid electrolyte requires high-temperature sintering or heat treatment at about 550° C. to obtain high ionic conductivity and shows low cycle stability due to side reactions with a negative electrode. On the other hand, the Li₇P₂S₈X(3Li₂S—P₂S₅—LiX)-type solid electrolyte is attracting attention because it is stable against a lithium metal negative electrode and can relatively lower a heat treatment temperature. However, the Li₇P₂S₈X(3Li₂S—P₂S₅—LiX)-type solid electrolytes also require improvement in ionic conductivity, and efforts to improve the above-mentioned problems of sulfide-based solid electrolytes are still needed.

### RELATED ART DOCUMENT

### Patent Document

(Patent Document 1) Korea Laid-Open Patent Publication No. 10-2017-0036017

### DISCLOSURE

### Technical Problem

The present invention is directed to providing a sulfide-based solid electrolyte having high ionic conductivity and stability against a lithium metal negative electrode.

### Technical Solution

The present invention provides a sulfide-based solid electrolyte in which an Li₂S—P₂S₅—LiX (where X is F, Cl, Br, or I) or Li₂S—P₂S₅—LiX—LiX′ (where X and X′ are F, Cl, Br, or I, and X and X′ are different elements)-type sulfide-based solid electrolyte system is doped with a metal or metalloid.

As one embodiment, the sulfide-based solid electrolyte may be represented by Chemical

Formula 1 below.

Li₇MₐP_{2-b}S₈X_{(1-c)}X′_{c} [Chemical Formula 1]

in Chemical Formula 1, M is a post-transition metal or metalloid, X and X′ are each selected from F, Cl, Br, and I, X and X′ are different elements, and 0<a≤0.5, 0<b≤0.4, and 0<c≤1 are satisfied.

As one embodiment, the sulfide-based solid electrolyte may be represented by Chemical Formula 2 below.

LiₐM_{b}P_{2-b}S₈X_{(1-c)}X′_{c} [Chemical Formula 2]

in Chemical Formula 2, M is a post-transition metal or metalloid, X and X′ are each selected from F, Cl, Br, and I, X and X′ are different elements, and 0<a≤0.5, 0<b≤0.5 and 0<c≤1 are satisfied.

As one embodiment, M may be Sn, Si, Sb, or Bi.

As one embodiment, X may be I and X′ may be Br.

As one embodiment, 0<c≤0.3 may be satisfied.

As one embodiment, the sulfide-based solid electrolyte may have peaks at 89.5±1 ppm and 77±1 ppm in a ³¹P MAS NMR spectrum.

As one embodiment, the sulfide-based solid electrolyte may have peaks at 2θ=19.8°±0.5°, 23.4°±0.5°, 29.1°±0.5°, or 40.6°±0.5° in X-ray diffraction measurement using CuKα rays.

In addition, the present invention provides a method of preparing a sulfide-based solid electrolyte, including: an amorphization process of mixing and pulverizing Li₂S, P₂S₅, LiX, and a doping material including a post-transition metal or metalloid to obtain an amorphous solid electrolyte powder; and a heat treatment process of heat-treating the amorphous solid electrolyte, wherein X is F, Cl, Br, or I.

As one embodiment, the amorphization process may further include LiX′, wherein X′ is F, Cl, Br, or I, and may be an element different from X.

As one embodiment, the amorphization process may be performed by ball milling, and the ball milling may be performed at 300 rpm to 500 rpm for 6 to 18 hours.

As one embodiment, the heat treatment process may be performed at 150° C. to 300° C. for 2 to 10 hours.

In addition, the present invention provides an all-solid-state battery including a positive electrode, a negative electrode, and the sulfide-based solid electrolyte of claim 1.

As one embodiment, the positive electrode may include at least one selected from the group consisting of Li₂S, S, LiMn₂O₄, LiNi_{0.8}Co_{0.1}Mn_{0.1}O₂, LiNi_{0.6}Co_{0.2}Mn_{0.2}O₂, LiCoO₂, LiFePO₄, LiNi_{0.5}Mn_{1.5}O₄, and LiNi_{0.8}Co_{0.15}Al_{0.05}O₂.

As one embodiment, the negative electrode may include at least one selected from the group consisting of Li, In, stainless steel, TiS, SnS, FeS₂, graphitic carbon, and alloys thereof.

In addition, the present invention provides a positive electrode composite including: a positive electrode material including at least one selected from the group consisting of Li₂S, S, LiMn₂O₄, LiNi_{0.8}Co_{0.1}Mn_{0.1}O₂, LiNi_{0.6}Co_{0.2}Mn_{0.2}O₂, LiCoO₂, LiFePO₄, LiNi_{0.5}Mn_{1.5}O₄, and LiNi_{0.8}Co_{0.15}Al_{0.05}O₂; the sulfide-based solid electrolyte of claim 1; and a conductive material including at least one selected from the group consisting of activated carbon, graphene oxide, carbon nanotubes, and carbon black.

In addition, the present invention provides an all-solid-state battery including the positive electrode composite.

### Advantageous Effects

The present invention can provide a sulfide-based solid electrolyte that has high ionic conductivity, stability against a lithium metal negative electrode, and excellent electrochemical cycle characteristics by doping a compound including Li, P, S, and a halogen element with a metal.

### DESCRIPTION OF DRAWINGS

FIG. 1 shows XRD patterns of Reference Example 1 and Comparative Examples 1 to 3.

FIG. 2 shows XRD patterns of Example 2 and Examples 4 to 6.

FIG. 3 shows XRD patterns of Examples 7 to 9.

FIG. 4 shows a DSC curve of Reference Example 1.

FIGS. 5A to 5D are views of cryo-TEM images, high-resolution lattice planes, and SAED patterns at −175° C. for Reference Example 1, and FIGS. 5E to 5H are views of cryo-TEM images, high-resolution lattice planes, and SAED patterns at −175° C. for Example 1.

FIG. 6 shows ⁷Li MAS NMR spectra of Reference Example 1, Example 1 and Example 4.

FIG. 7 shows ³¹P MAS NMR spectra of Reference Example 1, Example 1 and Example 4.

FIG. 8 shows XPS spectra of Reference Example 1, Example 4, and Example 6.

FIG. 9 shows laser Raman spectra of Reference Example 1, Example 4, and Example 6.

FIG. 10 shows cyclic voltammetry measurement graphs of Reference Example 1 and Comparative Example 3.

FIG. 11 shows cyclic voltammetry measurement graphs of Example 4 and Examples 7 to 9.

FIG. 12 shows time-voltage graphs of Reference Example 1 and Comparative Example 3.

FIG. 13 shows time-voltage graphs of Example 4 and Examples 7 to 9.

### MODES OF THE INVENTION

Since the present invention can be subject to various changes and have various embodiments, specific embodiments are illustrated in the drawings and described specifically in the detailed description.

However, this is not intended to limit the present invention to specific embodiments, and it should be understood to include all modifications, equivalents and substitutes included in the spirit and scope of the present invention.

In the present invention, it is to be understood that the terms “include(s)” or “have (has)” and the like are intended to specify the presence of stated features, numbers, steps, operations, components, components or combinations thereof, but do not preclude the presence or addition of one or more other features or numbers, steps, operations, components and combinations thereof.

Accordingly, the configurations shown in embodiments described herein are only preferred embodiments of the present invention and are not intended to represent all of the spirit of the invention, and that there may be various equivalents and modifications that may be substituted for them at the time of this application.

The present invention provides a sulfide-based solid electrolyte in which an Li₂S—P₂S₅—LiX (where X is F, Cl, Br, or I) or Li₂S—P₂S₅—LiX—LiX′ (where X and X′ are F, Cl, Br, or I, and X and X′ are different elements)-type sulfide-based solid electrolyte system is doped with a metal or metalloid.

A sulfide-based solid electrolyte including sulfur(S) exhibits higher ionic conductivity, mechanical stability, and electrochemical stability against lithium metal than oxide-based solid electrolytes. Li₃PS₄, Li₇P₃S₁₁, or Li₂PS₆ is known as such sulfide-based solid electrolytes, and in particular, a halogenated Li₂S—P₂S₅—LiX (where X is F, Cl, Br, or I) or Li₂S—P₂S₅—LiX—LiX′ (where X and X′ are F, Cl, Br, or I, and X and X′ are different elements)-type solid electrolyte has an advantage of high ionic conductivity due to a novel crystal structure.

Specifically, in a 3Li₂S—P₂S₅-(1-c)LiX-cLiX′(Li₇P₂S₈X_{(1-c)}X′_{c}) (where X and X′ are each F, Cl, Br, or I, X and X′ are different elements, and 0≤c≤1 is satisfied)-type solid electrolyte, a halogen is inserted into an Li₂S—P₂S₅ crystal structure to form an S²⁻/X⁻ or S²⁻/X′⁻ structure complex, thereby changing the crystal structure.

The changed crystal structure shows peaks at 2θ=19.8°±0.5°, 23.4°±0.5°, 29.1°±0.5°, or 40.6°±0.5° in X-ray diffraction measurement using CuKα rays, and since crystal structures at the peaks exhibit relatively high ionic conductivity, the ionic conductivity of a solid electrolyte including these peaks (hereinafter, referred to as a high ionic conductivity phase) may be increased.

However, phases having the peaks need to have high crystallinity, and require a high-temperature heat treatment process to have high crystallinity. When high-temperature heat treatment is performed for high crystallinity, a crystal structure having relatively low ionic conductivity (hereinafter, referred to as a low ionic conductivity phase) with peaks at 2θ=27.8°±0.5°, 32.2°±0.5°, or 55.2°±0.5° is created, and thus the ionic conductivity of the solid electrolyte is lowered.

The present invention provides a sulfide-based solid electrolyte that does not form a low ionic conductivity phase, has mechanical stability and electrochemical stability while having high ionic conductivity, and is stable even against moisture by doping an Li₂S—P₂S₅—LiX (X=halogen element)-based or Li₂S—P₂S₅—LiX—LiX′ (X and X′=halogen element)-based solid electrolyte system, specifically, a 3Li₂S—P₂S₅-(1-c)LiX-cLiX′(Li₇P₂S₈X_{(1-c)}X′_{c}) (where X and X′ are each F, Cl, Br, or I, X and X′ are different elements, and 0≤c≤1 is satisfied)-type solid electrolyte system with a metal or metalloid. Here, the metal may be a post-transition metal.

Specifically, the sulfide-based solid electrolyte according to the present invention may be represented by Chemical Formula 1 below.

Li₇MₐP_{2-b}S₈X_{(1-c)}X′_{c} [Chemical Formula 1]

in Chemical Formula 1, M is a post-transition metal or metalloid, X and X′ are each selected from F, Cl, Br, and I, X and X′ are different elements, and 0<a≤0.5, 0<b≤0.4, and 0<c<1 may be satisfied.

In addition, the sulfide-based solid electrolyte according to the present invention may be represented by Chemical Formula 2 below.

Li_{d}MₑP₂₋ₑS₈X_{(1-c)}X′_{c} [Chemical Formula 2]

in Chemical Formula 2, M is a post-transition metal or metalloid, X and X′ are each selected from F, Cl, Br, and I, X and X′ are different elements, and 0<d≤0.5, 0<e≤0.5, and 0<c≤1 may be satisfied.

M may be Sn, Si, Sb, or Bi in terms of forming a bond with S, improving ionic conductivity, and stability.

a may be 0<a≤0.4, 0<a≤0.3, or 0<a≤0.2, and b may be 0<b≤0.32, 0<b≤0.24, or 0<b≤0.16. When a and b exceed the above ranges, the ionic conductivity of the solid electrolyte may be lowered due to an increase in the low ionic conductivity phase and the impurity phase, and stability against the lithium metal negative electrode may be lowered.

d may be 0<d≤0.4, 0<d≤0.3, or 0<d≤0.2, and e may be 0<e≤0.4, 0<e≤0.3, or 0<e≤0.2. When d and e exceed the above ranges, the ionic conductivity of the solid electrolyte may be lowered due to an increase in the low ionic conductivity phase and the impurity phase, and stability against the lithium metal negative electrode may be lowered.

X and X′ may be different elements, and may each be I or Br. When X and X′ include I and Br, the peak intensity of a high ionic conductivity phase increases and impurity peaks are minimized, thereby improving ionic conductivity. Preferably, X may be I, and X′ may be Br. In this case, c may satisfy 0<c<0.5, 0<c<0.4, or 0<c<0.3. In the sulfide-based solid electrolyte, when a proportion of I is increased as described above, the peak intensity of the high ionic conductivity phase increases and impurity peaks are minimized, thereby improving ionic conductivity.

The sulfide-based solid electrolyte may have peaks at 89.5±1 ppm and 77±1 ppm in a ³¹P MAS NMR spectrum. The 89.5±1 ppm peak is due to PS₄³⁻ corresponding to a γ-Li₃PS₄ phase, and the 77±1 ppm peak corresponds to the presence of a P atom at a 2b site. When the sulfide-based solid electrolyte has the above peaks, it may have stability against the lithium metal negative electrode and increased ionic conductivity.

In addition, the sulfide-based solid electrolyte may have characteristic peaks at 131.4±0.2 eV and 132.2±0.2 eV corresponding to P 2p_{3/2} in a P 2p XPS spectrum, and may have characteristic peaks at 161.0±0.2 eV and 162.2±0.2 eV corresponding to S 2p_{3/2} in a S 2p XPS spectrum. The characteristic peaks of P and S are peaks corresponding to a PS₄³⁻ system, and by including these peaks, stability against the lithium metal negative electrode can be obtained and ionic conductivity can be increased.

In addition, the sulfide-based solid electrolyte may have peaks at 2θ=19.8°±0.5°, 23.4°±0.5°, 29.1°±0.5°, or 40.6°±0.5° in X-ray diffraction measurement using CuKα rays. Specifically, the sulfide-based solid electrolyte may have peaks at 2θ=19.8°±0.5°, 23.4°±0.5°, 29.1°±0.5°, and 40.6°±0.5° in X-ray diffraction measurement using CuKα rays. The peak represents a high ionic conductivity phase, and when the peak is included, the ionic conductivity of the solid electrolyte can be increased.

In addition, the sulfide-based solid electrolyte may have peaks at 2θ=37.4°±0.5° or 46.4°±0.5° in X-ray diffraction measurement using CuKα rays. Specifically, the sulfide-based solid electrolyte may have peaks at 2θ=37.4°±0.5° or 46.4°±0.5° in X-ray diffraction measurement using CuKα rays. Such a peak may have high ionic conductivity and may appear by including a post-transition metal or metalloid.

In this case, the peaks at 2θ=37.4°±0.5° or 46.4°±0.5° may have a stronger peak intensity than a system before doping with a post-transition metal or metalloid.

In addition, the peaks at 2θ=19.8°±0.5°, 23.4°±0.5°, 29.1°±0.5°, 37.4°±0.5°, 40.6°±0.5°, or 46.4°±0.5° may be shifted to a lower 2θ value than a system before doping with the post-transition metal or metalloid.

The ionic conductivity of the solid electrolyte according to the present invention may be 3.30 mScm⁻¹ or more, for example, 4.50 mScm⁻¹ or more, 6.0 mScm⁻¹ or more, 7.0 mScm⁻¹ or more, or 7.20 mScm⁻¹ or more. An upper limit of the ionic conductivity of the solid electrolyte is not limited. By having the above ionic conductivity, the efficiency of the battery to which the solid electrolyte according to the present invention is applied can be improved.

In addition, the present invention provides a method of preparing a sulfide-based solid electrolyte, including: an amorphization process of mixing and pulverizing Li₂S, P₂S₅, LiX, and a doping material including a post-transition metal or metalloid to obtain an amorphous solid electrolyte powder; and a heat treatment process of heat-treating the amorphous solid electrolyte, wherein X is F, Cl, Br, or I.

Alternatively, the present invention provides a method of preparing a sulfide-based solid electrolyte, including: an amorphization process of mixing and pulverizing Li₂S, P₂S₅, LiX, and a doping material including a post-transition metal or metalloid to obtain an amorphous solid electrolyte powder; and a heat treatment process of heat-treating the amorphous solid electrolyte, wherein X and X′ are each F, Cl, Br or I, and may be different elements.

The post-transition metal or metalloid may be Sn, Si, Sb, or Bi in terms of forming a bond with S, improving ionic conductivity, and stability.

The doping material is a compound including the post-transition metal or metalloid, and may be Bi₂S₃, Sb₂S₃, Si, or SnS. In this case, when the doping material is Si or SnS, S may be further included.

The amorphization process is a process of mixing and pulverizing starting materials, that is, Li₂S, P₂S₅, LiX, LiX′, and a doping material including a post-transition metal or metalloid to amorphize a mixture and may be advantageous for formation of a high ionic conductivity phase when performing amorphization.

The amorphization process may be performed by mechanical milling, which includes ball milling, turbo milling, disk milling, or vibration milling. The amorphization process may be performed, for example, by ball milling, and may be specifically performed by planetary ball milling. In this case, the ball milling may be performed at 300 rpm to 500 rpm for 6 to 18 hours.

In addition, the heat treatment process may be performed at 150° C. to 300° C. for 2 to 10 hours. The heat treatment temperature is important because it controls the ratio of the high ionic conductivity phase and a low ionic conductivity phase. Specifically, an Li₂S—P₂S₅—LiX-type solid electrolyte has two exothermic peaks in DSC analysis, wherein the first exothermic peak represents the formation of an Li₇P₂S₈X phase, and the second exothermic peak represents decomposition into Li₃PS₄ and LiBr. Similarly, in an Li₂S—P₂S₅—LiX—LiX′ system, a first exothermic peak represents the formation of Li₇P₂S₈XX′, and a second exothermic peak represents decomposition. Therefore, a crystal structure of the solid electrolyte may be controlled by adjusting the heat treatment temperature.

Specifically, when heat treatment is performed at a temperature between the first peak and the second peak in DSC analysis, it is possible to prevent the formation of impurities by decomposition into Li₃PS₄.

Therefore, in a method of preparing the solid electrolyte according to the present invention, the heat treatment process may be performed at 150° C. to 300° C., for example, a temperature of the heat treatment process may be 180° C. to 250° C., 190° C. to 240° C., or 190° C. to 220° C.

In addition, the present invention may provide an all-solid-state battery including a positive electrode, a negative electrode, and the above-described sulfide-based solid electrolyte.

The positive electrode may be at least one selected from the group consisting of Li₂S, S, LiMn₂O₄, LiNi_{0.8}Co_{0.1}Mn_{0.1}O₂, LiNi_{0.6}Co_{0.2}Mn_{0.2}O₂, LiCoO₂, LiFePO₄, LiNi_{0.5}Mn_{1.5}O₄, and LiNi_{0.8}Co_{0.15}Al_{0.05}O₂, and the negative electrode may include at least one selected from the group consisting of Li, In, stainless steel, TiS, SnS, FeS₂, graphitic carbon, and alloys thereof.

In addition, as another embodiment, the present invention may provide a positive electrode composite including: a positive electrode material including at least one selected from the group consisting of Li₂S, S, LiMn₂O₄, LiNi_{0.8}Co_{0.1}Mn_{0.1}O₂, LiNi_{0.6}Co_{0.2}Mn_{0.2}O₂, LiCoO₂, LiFePO₄, LiNi_{0.5}Mn_{1.5}O₄, and LiNi_{0.8}Co_{0.15}Al_{0.05}O₂; the above-described sulfide-based solid electrolyte; and a conductive material including at least one selected from the group consisting of activated carbon, graphene oxide, carbon nanotubes, and carbon black.

The carbon black may be super-P or Ketjen black.

In addition, the present invention may provide an all-solid-state battery including the positive electrode composite. At this time, the all-solid-state battery may include a positive electrode layer including the positive electrode composite; a negative electrode layer including a negative electrode material; and a solid electrolyte layer formed between the positive electrode layer and the negative electrode layer.

Hereinafter, specific examples of the present invention are presented. However, the examples described below are only intended to specifically illustrate or explain the present invention, and the present invention should not be limited thereto.

### Examples 1 to 6

As raw materials, Li₂S (99.98%, Sigma Aldrich), P₂S₅ (99%, Sigma Aldrich), LiI (≥99%, Sigma Aldrich), LiBr (≥99%, Sigma Aldrich), SnS and S were used as starting materials to prepare a solid electrolyte material by a high-energy dry ball milling process. Li₂S, P₂S₅, LiI, LiBr, SnS and S as starting materials were mixed in a molar ratio of 3:0.98:0.75:0.25:0.05:0.05. The mixture was then ground using a mortar and pestle for 15 minutes and transferred to an 80 ml planetary ball mill alumina container. 25 zirconia balls were then added and then the container was sealed. The alumina container was taken out of a glove box and mounted on a ball mill machine (Pulverisette, Fritsch), and ball milling was performed at 400 rpm for 12 hours. During the ball milling process, a rotation direction was changed every 30 minutes with a break of 10 minutes to prevent overheating and perform uniform mixing/milling. After the ball milling process, a product was collected and pulverized for 15 minutes to obtain a fine amorphous solid electrolyte powder. Thereafter, the amorphous solid electrolyte was heat-treated at 200° C. for 5 hours at a heating rate of 2° C./min to prepare the solid electrolyte of Example 1.

Examples 2 to 6 were prepared in the same manner as in Example 1, except that the molar ratio in Example 1 was changed as shown in Table 1 below.

TABLE 1

| Classification | Li₂S | P₂S₅ | LiI | LiBr | SnS | S | Chemical Formula |
|---|---|---|---|---|---|---|---|
| Example 1 | 3 | 0.98 | 0.75 | 0.25 | 0.05 | 0.05 | Li₇Sn_{0.05}P_{1.96}S₈I_{0.75}Br_{0.25} |
| Example 2 | 3 | 0.96 | 0.75 | 0.25 | 0.1 | 0.1 | Li₇Sn_{0.1}P_{1.92}S₈I_{0.75}Br_{0.25} |
| Example 3 | 3 | 0.92 | 0.75 | 0.25 | 0.2 | 0.2 | Li₇Sn_{0.2}P_{1.86}S₈I_{0.75}Br_{0.25} |
| Example 4 | 3.025 | 0.975 | 0.75 | 0.25 | 0.05 | 0.05 | Li_{7.05}Sn_{0.05}P_{1.95}S₈I_{0.75}Br_{0.25} |
| Example 5 | 3.05 | 0.95 | 0.75 | 0.25 | 0.1 | 0.1 | Li_{7.1}Sn_{0.1}P_{1.9}S₈I_{0.75}Br_{0.25} |
| Example 6 | 3.1 | 0.9 | 0.75 | 0.25 | 0.2 | 0.2 | Li_{7.2}Sn_{0.2}P_{1.8}S₈I_{0.75}Br_{0.25} |

### Examples 7 to 9

Examples 7 to 9 were prepared in the same manner as in Example 1, except that Si and S (Example 7), Sb₂S₃ (Example 8), and Bi₂S₃ (Example 9) were used instead of SnS and S as starting materials in Example 1, and the molar ratio was changed as shown in Table 2 below.

TABLE 2

| Classification | Starting materials and molar ratio | | | | | | Chemical Formula |
|---|---|---|---|---|---|---|---|
| Example 7 | Li₂S | P₂S₅ | LiI | LiBr | Si | S | Li_{7.05}Si_{0.05}P_{1.95}S₈I_{0.75}Br_{0.25} |
| | 3.025 | 0.975 | 0.75 | 0.25 | 0.05 | 0.1 | |
| Example 8 | Li₂S | P₂S₅ | LiI | LiBr | Sb₂S₃ | — | Li_{7.05}Sb_{0.05}P_{1.95}S₈I_{0.75}Br_{0.25} |
| | 3.025 | 0.975 | 0.75 | 0.25 | 0.025 | — | |
| Example 9 | Li₂S | P₂S₅ | LiI | LiBr | Bi₂S₃ | — | Li_{7.05}Bi_{0.05}P_{1.95}S₈I_{0.75}Br_{0.25} |
| | 3.025 | 0.975 | 0.75 | 0.25 | 0.025 | — | |

### Reference Example 1, Comparative Example 1, and Comparative Example 2

As raw materials, Li₂S (99.98%, Sigma Aldrich), P₂S₅ (99%, Sigma Aldrich), LiI (≥99%, Sigma Aldrich), and LiBr (≥99%, Sigma Aldrich) were used as starting materials to prepare a solid electrolyte material by a high-energy dry ball milling process. Li₂S, P₂S₅, LiI, and LiBr were mixed in a molar ratio of 3:1:0.75:0.25. The mixture was then ground using a mortar and pestle for 15 minutes and transferred to an 80 ml planetary ball mill alumina container. 25 zirconia balls were then added and then the container was sealed. The alumina container was taken out of a glove box and mounted on a ball mill machine (Pulverisette, Fritsch), and ball milling was performed at 400 rpm for 12 hours. During the ball milling process, a rotation direction was changed every 30 minutes with a break of 10 minutes to prevent overheating and perform uniform mixing/milling. After the ball milling process, a product was collected and pulverized for 15 minutes to obtain a fine amorphous solid electrolyte powder. Thereafter, the amorphous solid electrolyte was heat-treated at 200° C. for 5 hours at a heating rate of 2° C./min to prepare the solid electrolyte of Reference Example 1.

Comparative Examples 1 and 2 were prepared in the same manner as in Reference Example 1, except that the molar ratio in Reference Example 1 was changed as shown in Table 3 below.

TABLE 3

| Classification | Li₂S | P₂S₅ | LiI | LiBr | Chemical Formula |
|---|---|---|---|---|---|
| Reference | 3 | 1 | 0.75 | 0.25 | Li₇P₂S₈I_{0.75}Br_{0.25} |
| Example 1 | | | | | |
| Comparative | 3 | 1 | 0.5 | 0.5 | Li₇P₂S₈I_{0.5}Br_{0.5} |
| Example 1 | | | | | |
| Comparative | 3 | 1 | 0.25 | 0.75 | Li₇P₂S₈I_{0.25}Br_{0.75} |
| Example 2 | | | | | |

### Comparative Example 3

Comparative Example 3 was prepared in the same manner as Reference Example 1, except that Li₂S (99.98%, Sigma Aldrich), P₂S₅ (99%, Sigma Aldrich), LiI (≥99%, Sigma Aldrich), and LiCl (≥99%, Sigma Aldrich) were used as raw materials, and the materials were mixed in the molar ratio shown in Table 4 below.

TABLE 4

| Classification | Li₂S | P₂S₅ | LiI | LiCl | Chemical Formula |
|---|---|---|---|---|---|
| Comparative | 3 | 1 | 0.75 | 0.25 | Li₇P₂S₈I_{0.75}Cl_{0.25} |
| Example 3 | | | | | |

### Experimental Example

### X-Ray Diffraction Analysis (XRD)

A crystal structure and crystal phase of the solid electrolyte were identified by a Rigaku-Ultima (IV) X-ray diffractometer (XRD) using Cu Kα radiation with a wavelength of 1.5418 Å. Prior to XRD analysis, a solid electrolyte powder was loaded into an airtight XRD holder in an argon-filled glove box to avoid exposure to air and moisture. The XRD analysis was performed within a 2θ range of 10 to 80° with a magnitude of 0.01 s⁻¹.

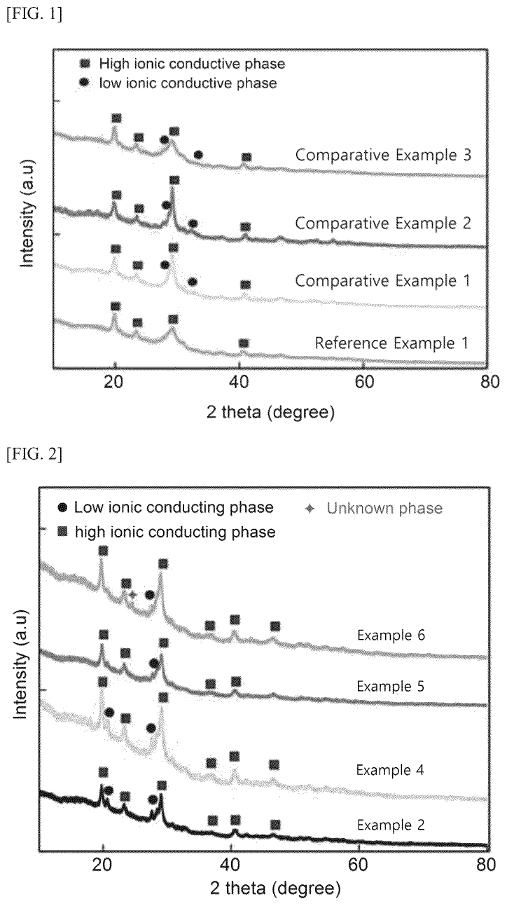

XRD patterns of Reference Example 1 and Comparative Examples 1 to 3 are shown in FIG. 1. Reference Example 1 showed peaks at 2θ=19.8±0.5°, 23.4±0.5°, 29.1±0.5° and 40.6±0.5° indicating a high ionic conductivity phase. Comparative Examples 1 to 3 showed peaks at 2θ=28.0±0.5° and 34.8±0.5°, and these peaks indicated a low ionic conductivity phase. That is, Comparative Examples 1 to 3 had both a high ionic conductivity phase and a low ionic conductivity phase.

XRD patterns of the sulfide-based solid electrolytes of Examples 2 and 4 to 6 are shown in FIG. 2. In the sulfide-based solid electrolytes of Examples 2 and 4 to 6, there was a mixture of the low ionic conductivity phase and the high ionic conductivity phase, and in particular, the strength of the high ionic conductivity phase was high in Examples 4 to 6. In Example 6, where the Sn concentration was high, some impurity phases were observed.

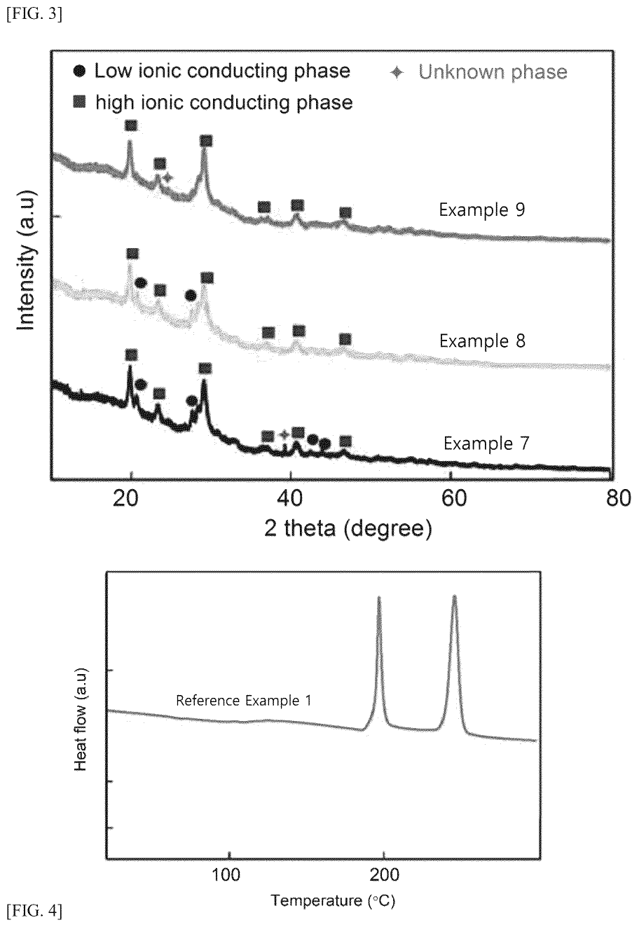

XRD patterns of the sulfide-based solid electrolytes of Examples 7 to 9 are shown in FIG. 3. An impurity phase was observed in Examples 7 and 8, and a low ionic conductivity phase was not observed in Example 9.

In particular, referring to FIGS. 2 and 3, Example 2, Examples 4 to 6, and Examples 7 to 9 showed peaks at 2θ=19.8°±0.5°, 23.4°±0.5°, 29.1°±0.5°, 37.4°±0.5°, 40.6°±0.5° and 46.4°±0.5° indicating a high ionic conductivity phase, and particularly, showed increased peak intensity at 37.4°±0.5° and 46.4°±0.5° compared to Reference Example 1 and Comparative Examples 1 to 3.

### Differential Scanning Calorimetry (DSC)

Differential scanning calorimetry was performed on the solid electrolyte powder prepared in Reference Example 1 before heat treatment. Specifically, 4 mg to 7 mg samples were sealed in an aluminum container of a glove box and loaded into a differential scanning calorimeter instrument, TA Instruments (DSC Q20 V24.9 Build 121). Thermal analysis was performed between 10° C. and 300° C. at a rate of 10° C./min. A DSC curve of the solid electrolyte of Reference Example 1 is shown in FIG. 4. Two exothermic peaks (T1 and T2) were observed in the DSC curve. The first exothermic peak (T1) is about 200° C., indicating the formation of a first phase (Li₇P₂S₈I_{0.75}Br_{0.25}). The second exothermic peak (T2) represents a phase change around 245° C., that is, decomposition of the Li₇P₂S₈I_{0.75}Br_{0.25} solid electrolyte. The difference between the two exothermic peaks is 45° C.

### Structural and Morphological Analysis

Structural and morphological analysis was performed through nuclear magnetic resonance spectroscopy (NMR), field emission scanning electron microscopy and laser Raman analysis.

Specifically, nuclear magnetic resonance spectroscopy was used to study ⁷Li and ³¹P chemical shifts using a nuclear magnetic resonance spectrometer (VARIAN, VNMRS 600), and a 40 kHz frequency was used for analysis. Active surface functional groups of the electrolyte were studied by X-ray photoelectron spectroscopy (XPS) using a focused Al Kα (1.487 keV) monochromatic filter in an argon atmosphere. A size of an area spot used for analysis was 500 μm. The microstructure characteristics of the fabricated solid electrolyte were confirmed by cryo-transmission electron microscopy analysis using Cryo-TEM and JEM-2100F (JEOL) at an accelerating voltage of 200 kV. First, the samples were mounted on a laced carbon grid and loaded into a Cryo-TEM holder (Double tilt LN2 Atmos Defend Holder, Mel-Build, Japan) under an argon-filled glove box. The TEM holder was transported in a closed shuttle for argon protection and grid to prevent air exposure. After transferring the holder to the TEM chamber, the samples on the grid were cooled to about −175° C. using liquid nitrogen. Laser Raman analysis was used to elucidate the structural units of the electrolyte using a Raman spectrometer (Thermo Scientific, DXR Raman) with an excitation wavelength of 532 nm and a power of 8 mW.

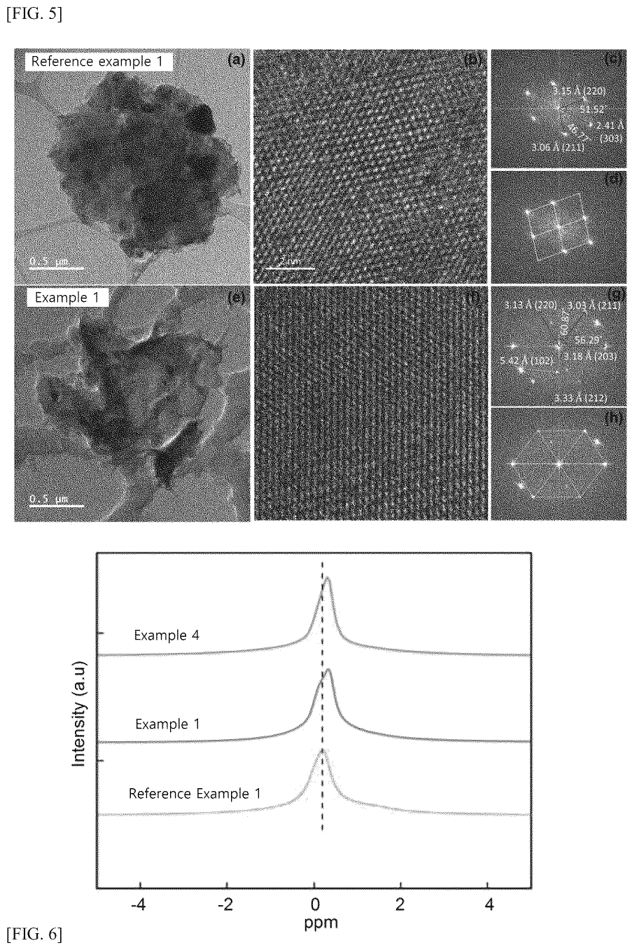

The microstructure characteristics of the solid electrolytes prepared according to Reference Example 1 (Li₇P₂S₈I_{0.75}Br_{0.25}) and Example 4 (Li_{7.05}Sn_{0.05}P_{1.95}S₈I_{0.75}Br_{0.25}) were investigated through cryo-TEM analysis, and each image is shown in FIG. 5. Referring to FIG. 5, in the cryo-TEM analysis, it was confirmed that a particle size of the solid electrolyte prepared according to Reference Example 1 (Li₇P₂S₅I_{0.75}Br_{0.25}) and Example 4 (Li_{7.05}Sn_{0.05}P_{1.95}S₈I_{0.75}Br_{0.25}) was ˜1.5 μm. A high-resolution lattice image with multiple spots in a selected area diffraction pattern (SAED) for the solid electrolyte (Li₇P₂S₈I_{0.75}Br_{0.25}) according to Reference Example 1 indicates that the lattice planes are arranged in (220) and (211) directions, and this corresponds to P42 nmc and P4 nmm structures, respectively. In addition, a slightly distorted angle was observed in the same lattice plane direction while adding Sn to Li₇P₂S₈I_{0.75}Br_{0.25} according to Example 4 (Li_{7.05}Sn_{0.05}P_{1.95}S₈I_{0.75}Br_{0.25}). Through this, it was confirmed that Sn atoms were successfully doped into the Li₇P₂S₈I_{0.75}Br_{0.25} solid electrolyte.

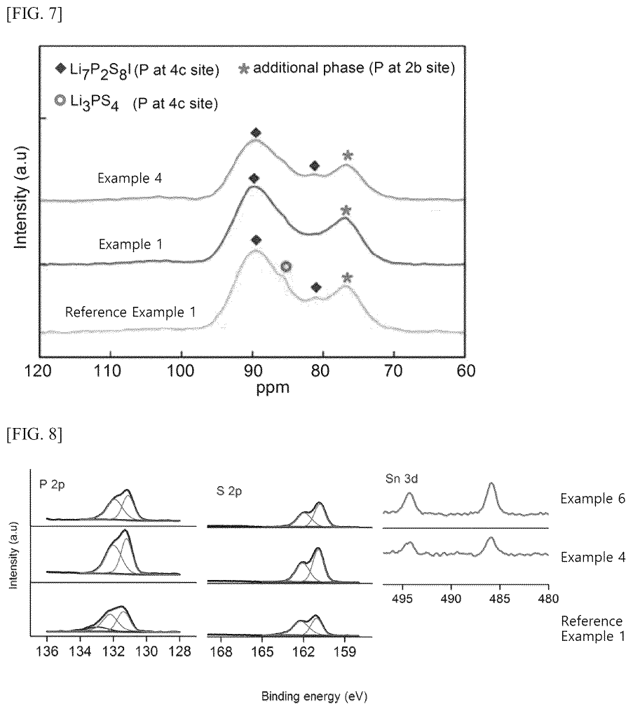

⁷Li and ³¹P MAS NMR spectra of the sulfide-based solid electrolytes prepared according to Reference Example 1, Example 1, and Example 4 are shown in FIGS. 6 and 7, respectively. Referring to FIG. 6, a peak position in the ⁷Li MAS NMR spectrum of Sn-doped solid electrolytes of Examples 1 and 4 was shifted by 0 to 0.2 ppm compared to the solid electrolyte prepared according to Reference Example 1. This chemical shift may be an effect of Sn ions. Referring to FIG. 7, two main peaks in the ³¹P MAS NMR spectrum were observed at 89.5 ppm and 77 ppm, respectively. The first characteristic peak is attributed to PS4³⁻ corresponding to the γ-Li₃PS₄ phase. The second characteristic peak appearing at 77 ppm corresponds to the presence of a P atom at a 2b site. Also, two small peaks observed at 85.5 ppm and 81.2 ppm correspond to the β-Li₃PS₄ phase and PS₄³⁻ coordination, respectively. ³¹P MAS NMR showed no peak shift due to Sn doping except for the disappearance of a β-Li₃PS₄ phase.

In addition, chemical states of the sulfide-based solid electrolytes prepared according to Reference Example 1, Example 4, and Example 6 were studied by XPS analysis, and respective P 2p and S 2p analysis spectra are shown in FIG. 8. The analyzed XPS spectrum of P 2p shows characteristic peaks at 131.4 eV and 132.2 eV corresponding to P 2p_{3/2}. Similarly, the analytical XPS spectrum of S 2p shows that the characteristic peaks observed at 161.0 eV and 162.2 eV correspond to S 2p_{3/2}. The characteristic peaks of P and S correspond to a PS₄³⁻ system. Small peak shifts were observed in P 2p and S 2p, which are characteristic peaks, by Sn doping. Therefore, it is clear that addition of Sn disrupted a P—S bond. The presence of Sn can also be confirmed by the characteristic peaks 485.2 and 494.2 eV.

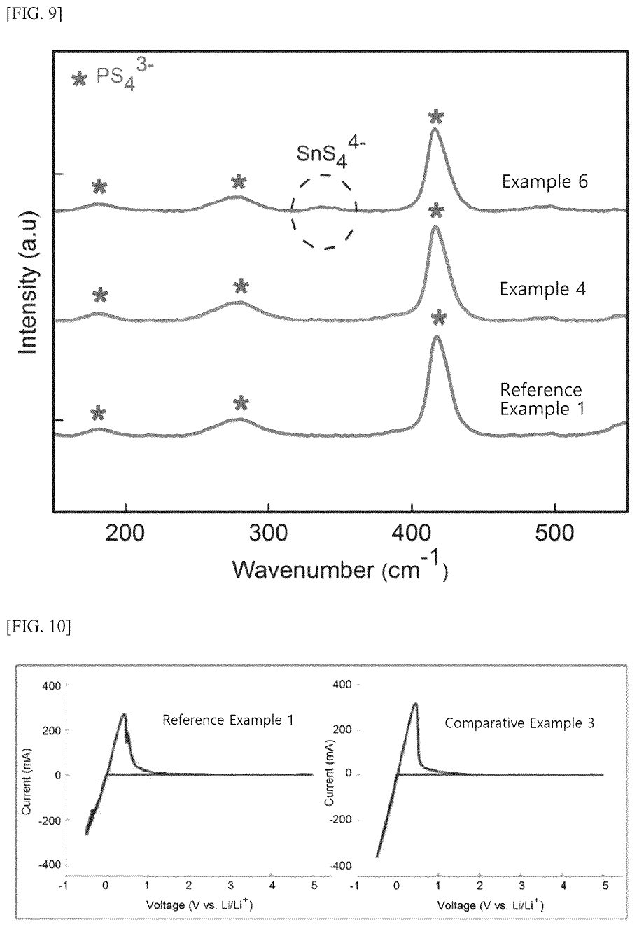

The characteristics of the Sn dopant in the solid electrolyte were confirmed by laser Raman analysis, and the corresponding spectra of Reference Example 1, Example 4, and Example 6 are shown in FIG. 9. Laser Raman analysis confirmed that the sulfide-based solid electrolyte exhibited a characteristic peak of PS4³⁻ corresponding to the formation of Li₃PS₄, which coincided well with the NMR and XPS results. In particular, even in the solid electrolyte prepared in Example 6, a small characteristic peak was observed at ˜340 cm⁻¹, which confirmed that the formation of SnS₄⁴⁻ and P-sites could be partially occupied by Sn atoms. However, the characteristic peak of SnS₄⁴⁻ was not observed in the sulfide-based solid electrolyte according to Example 4. This is judged to be due to a low Sn doping concentration.

### Ionic Conductivity

Ionic conductivity was measured by electrochemical impedance spectroscopy (EIS) using Biologic SP-300 in a frequency range of 7 MHz to 1 Hz at room temperature (25° C.). The ionic conductivity of the solid electrolyte was calculated using an ionic equation. Prior to analysis, a sample (250 mg) was compressed into pellets with a diameter of 10 mm and a thickness of 0.12 to 0.18 mm using hydraulic pressure. During pressing, a 50 μm indium foil was attached on both sides to ensure high contact and assembled into a pressure cell. The ionic conductivity of Reference Example 1, Examples 1 to 9, and Comparative Examples 1 to 3 are shown in Table 5 below.

TABLE 5

| | | Ionic Conductivity |
|---|---|---|
| Classification | Chemical Formula | (mS/cm) |
| Example 1 | Li₇Sn_{0.05}P_{1.96}S₈I_{0.75}Br_{0.25} | 4.93 |
| Example 2 | Li₇Sn_{0.1}P_{1.92}S₈I_{0.75}Br_{0.25} | 4.98 |
| Example 3 | Li₇Sn_{0.2}P_{1.86}S₈I_{0.75}Br_{0.25} | 3.45 |
| Example 4 | Li_{7.05}Sn_{0.05}P_{1.95}S₈I_{0.75}Br_{0.25} | 7.78 |
| Example 5 | Li_{7.1}Sn_{0.1}P_{1.9}S₈I_{0.75}Br_{0.25} | 7.44 |
| Example 6 | Li_{7.2}Sn_{0.2}P_{1.8}S₈I_{0.75}Br_{0.25} | 7.22 |
| Example 7 | Li_{7.05}Si_{0.05}P_{1.95}S₈I_{0.75}Br_{0.25} | 7.14 |
| Example 8 | Li_{7.05}Sb_{0.05}P_{1.95}S₈I_{0.75}Br_{0.25} | 6.01 |
| Example 9 | Li_{7.05}Bi_{0.05}P_{1.95}S₈I_{0.75}Br_{0.25} | 6.83 |
| Reference | Li₇P₂S₈I_{0.75}Br_{0.25} | 6.16 |
| Example 1 | | |
| Comparative | Li₇P₂S₈I_{0.5}Br_{0.5} | 5.79 |
| Example 1 | | |
| Comparative | Li₇P₂S₈I_{0.25}Br_{0.75} | 4.21 |
| Example 2 | | |
| Comparative | Li₇P₂S₈I_{0.75}Cl_{0.25} | 3.14 |
| Example 3 | | |

The lithium ionic conductivity of Reference Example 1 was 6.16 mScm⁻¹. In Comparative Examples 1 and 2, the ionic conductivity is lowered due to the presence of a low ionic conductivity phase as the concentration of Br increased. The ionic conductivity of the solid electrolytes prepared in Examples 1 to 3 showed a lower ionic conductivity value than that of Reference Example 1 due to impurity formation and a low ionic conductivity phase, as shown in XRD analysis. Meanwhile, Examples 4 to 6 exhibited higher ionic conductivity than Reference Example 1. This is due to the formation of a high-strength, high ionic conductivity phase and the formation of an SnS₄⁴⁻ phase. Formation of such a new phase may widen a lithium ion transport path and increase lithium ionic conductivity. As a result, the sulfide-based solid electrolyte prepared in Example 4 exhibited the highest ionic conductivity value of 7.78 mScm⁻¹. The lithium ionic conductivity of the sulfide-based solid electrolytes prepared in Examples 7 to 9 was higher than that of Reference Example 1. This is because the doping element improves ionic conductivity without changing a crystal structure. This result may be due to the formation of dopant-sulfur bonds and the expansion of the lithium ion transport pathway.

The ionic conductivity of the sulfide-based solid electrolyte prepared in Comparative Example 3 rapidly decreased due to the presence of a low ionic conductivity phase and impurities as Br was replaced with Cl.

### Electrochemical Characterization

A 2032-type coin cell was prepared in an argon-filled glove box and measured within a potential window of 0.5 V to 5.0 V at a scan rate of 1 mVs⁻¹ using Biologic SP 300. For measurement, a solid electrolyte pellet (0.2 g, diameter of 16 mm and thickness of less than 1 mm) was placed between a lithium metal negative electrode and a stainless steel (SS) positive electrode and assembled into the coin cell. Similarly, an Li/solid electrolyte/Li symmetric cell was assembled and subjected to galvanostatic long cycle testing at a current density of 0.5 mA cm⁻² with a cycle of 30 minutes using a MACCOR battery analysis system.

For charge and discharge analysis, LiNi_{0.8}Co_{0.1}Mn_{0.1}O₂ as a solid electrolyte and super-P were mixed at a weight ratio of 70:28:2 and ground using a mortar and pestle to prepare a positive electrode composite. To fabricate a pellet-type coin cell, 0.2 g of the solid electrolyte was first compressed into a pellet with a diameter of 16 mm and a thickness of ˜1 mm. Subsequently, the prepared positive electrode composite was spread on one side of the electrolyte and pressed at 250 bar. Finally, both sides of the pellet were covered with an indium foil or Li—In alloy to act as a current collector and negative electrode, respectively.

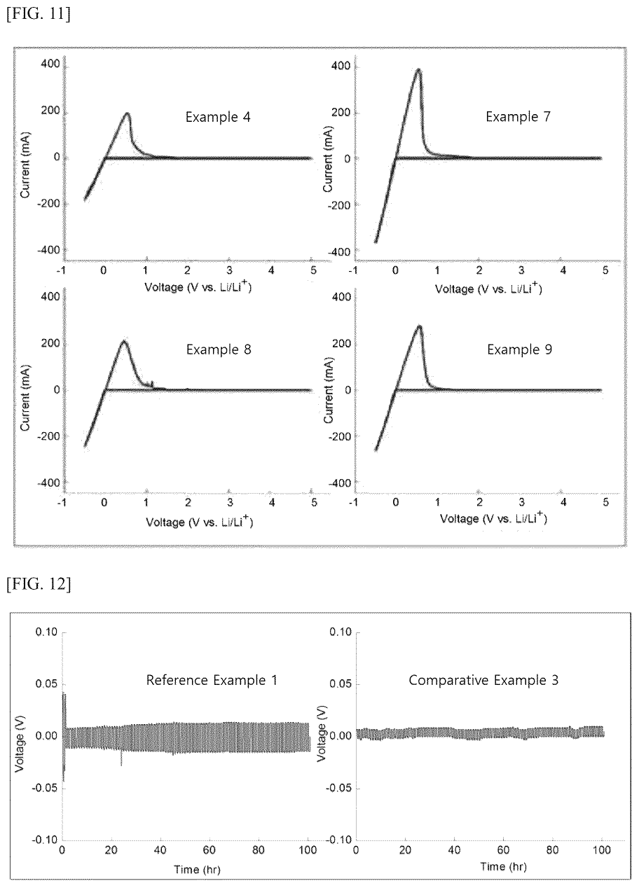

The cyclic voltammetry measurement results of the solid electrolytes prepared in Reference Example 1 and Comparative Example 3 are shown in FIG. 10, and the cyclic voltammetry measurement results of the solid electrolytes prepared in Examples 4 and 7 to 9 are shown in FIG. 11. The prepared solid electrolyte was electrochemically stable up to 5 V. No oxidation or reduction peaks were observed except for lithium dissolution and deposition peaks.

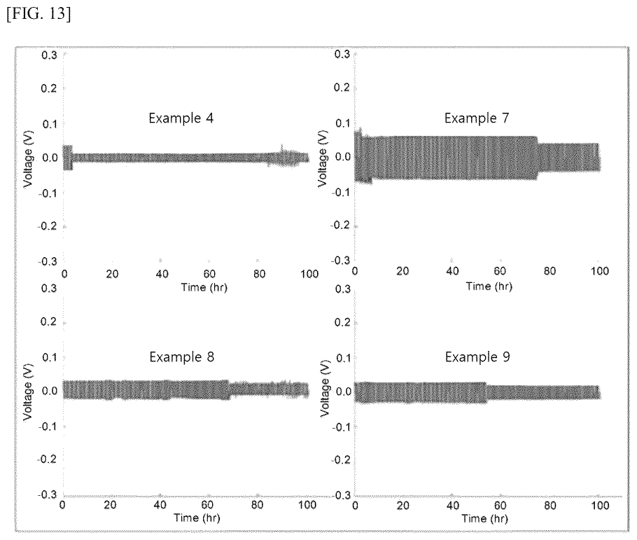

In addition, time-voltage graphs of the solid electrolytes prepared in Reference Example 1 and Comparative Example 3 are shown in FIG. 12, and time-voltage graphs of the solid electrolytes prepared in Example 4 and Examples 7 to 9 are shown in FIG. 13. In Example 4 and Example 8, small side reactions were observed in the initial cycle, but it was confirmed that they were stable against lithium metal after 100 charge and discharge cycles. The solid electrolytes prepared in Examples 7 and 9 exhibited high stability without side reactions.

1. A sulfide-based solid electrolyte in which a metal or metalloid is doped into an Li₂S—P₂S₅—LiX (where X is F, Cl, Br, or I) or Li₂S—P₂S₅—LiX—LiX′ (where X and X′ are F, Cl, Br, or I, and X and X′ are different elements)-type sulfide-based solid electrolyte system.

2. The sulfide-based solid electrolyte of claim 1, wherein the sulfide-based solid electrolyte is represented by Chemical Formula 1 below:
Li₇MₐP_{2-b}S₈X_{(1-c)}X′_{c} [Chemical Formula 1]
in Chemical Formula 1,
M is a post-transition metal or metalloid,
X and X′ are each one selected from F, Cl, Br, and I, and X and X′ are different elements, and
0<a≤0.5, 0<b≤0.4, and 0<c<1 are satisfied.

3. The sulfide-based solid electrolyte of claim 1, wherein the sulfide-based solid electrolyte is represented by Chemical Formula 2 below:
Li_{7+d}MₑP₂₋ₑS₈X_{(1-c)}X′_{c} [Chemical Formula 2]
in Chemical Formula 2,
M is a post-transition metal or metalloid,
X and X′ are each one selected from F, Cl, Br, and I, and X and X′ are different elements, and
0<d≤0.5, 0<e≤0.5, and 0<c≤1 are satisfied.

4. The sulfide-based solid electrolyte of claim 2, wherein M is Sn, Si, Sb, or Bi.

5. The sulfide-based solid electrolyte of claim 1, wherein X is I, and X′ is Br.

6. The sulfide-based solid electrolyte of claim 2, wherein 0<c≤0.3 is satisfied.

7. The sulfide-based solid electrolyte of claim 1, wherein the sulfide-based solid electrolyte has peaks at 89.5±1 ppm and 77±1 ppm in a ³¹P MAS NMR spectrum.

8. The sulfide-based solid electrolyte of claim 1, wherein the sulfide-based solid electrolyte has peaks at 2θ=19.8°±0.5°, 23.4°±0.5°, 29.1°±0.5°, or 40.6°±0.5° in X-ray diffraction measurement using CuKα rays.

9. A method of preparing a sulfide-based solid electrolyte, comprising:
an amorphization process of mixing and pulverizing Li₂S, P₂S₅, LiX, and a doping material including a post-transition metal or metalloid to obtain an amorphous solid electrolyte powder; and
a heat treatment process of heat-treating the amorphous solid electrolyte,
wherein X is F, Cl, Br, or I.

10. The method of claim 9, wherein the amorphization process further includes LiX′, and
X′ is F, Cl, Br, or I, and is an element different from X.

11. The method of claim 9, wherein the amorphization process is performed by ball milling, and
the ball milling is performed at 300 rpm to 500 rpm for 6 to 18 hours.

12. The method of claim 9, wherein the heat treatment process is performed at 150° C. to 300° C. for 2 to 10 hours.

13. An all-solid-state battery comprising a positive electrode, a negative electrode, and the sulfide-based solid electrolyte of claim 1.

14. The all-solid-state battery of claim 13, wherein the positive electrode includes at least one selected from the group consisting of Li₂S, S, LiMn₂O₄, LiNi_{0.8}Co_{0.1}Mn_{0.1}O₂, LiNi_{0.6}Co_{0.2}Mn_{0.2}O₂, LiCoO₂, LiFePO₄, LiNi_{0.5}Mn_{1.5}O₄, and LiNi_{0.8}Co_{0.15}Al_{0.05}O₂.

15. The all-solid-state battery of claim 13, wherein the negative electrode includes at least one selected from the group consisting of Li, In, stainless steel, TiS, SnS, FeS₂, graphitic carbon, and alloys thereof.

16. A positive electrode composite comprising:
a positive electrode material including at least one selected from the group consisting of Li₂S, S, LiMn₂O₄, LiNi_{0.8}Co_{0.1}Mn_{0.1}O₂, LiNi_{0.6}Co_{0.2}Mn_{0.2}O₂, LiCoO₂, LiFePO₄, LiNi_{0.5}Mn_{1.5}O₄, and LiNi_{0.8}Co_{0.15}Al_{0.05}O₂;
the sulfide-based solid electrolyte of claim 1; and
a conductive material including at least one selected from the group consisting of activated carbon, graphene oxide, carbon nanotubes, and carbon black.

17. An all-solid-state battery comprising the positive electrode composite of claim 16.

18. The sulfide-based solid electrolyte of claim 3, wherein M is Sn, Si, Sb, or Bi.

19. The sulfide-based solid electrolyte of claim 3, wherein 0<c≤0.3 is satisfied.
